(19) United States
(12) Patent Application Publication
(10) Pub. No.: US 2006/0158549 A1
(43) Pub. Date: Jul. 20, 2006

(54) Remote viewing apparatus

(76) Inventors: Antony Digweed, Botley (GB); Carl Ian Hitchcock, Southsea (GB)

Correspondence Address: John W. Greenwald;GARDNER GROFF, P.C., Paper Mill Village, Building 23, 600 Village Trace, Suite 300, Marietta, GA, 30067, US

(21) Appl. No.: 11/036,882

(22) Filed: Jan. 14, 2005

(51) Int. Cl. H04N 5/225

(52) U.S. Cl. 348/373

(57) ABSTRACT

A remote viewing apparatus comprising: a monitor which operatively displays a picture using a video signal; a telescopic pole; and a unit including a camera which operatively outputs a video signal to be used by the monitor; a waterproof camera housing in which the camera is enclosed; a wand which is releasably retained at one end of the telescopic pole; and a pliable mechanical connector which connects the camera housing to the wand and which can be reversibly bent by hand to, and retain, a curved shape. A plurality of interchangeable units can be provided with additional units having the pliable connector bifurcated in to two arms with the camera housing being provided on one of the arms and an auxiliary device provided on the other of the arms. Examples of auxiliary devices are light sources and magnets.

### FIELD OF INVENTION

The present invention relates to a remote viewing apparatus, one non-limiting application of which is for the underwater inspection of the hull, propellers and the like of leisure boats.

### BACKGROUND ART

Particularly for objects normally immersed in water, such as the hulls of boats, there is some difficulty in checking the need for repair or routine maintenance. For example, boats normally carry on the outside of the hull, underwater a so-called sacrificial anode. Such an anode is corroded by electrolysis as a result of leakage from the boats electrical supply and is designed as the weakest part of the system; so that it corrodes rather than other underwater metallic parts of the boat particularly the propellers. Conventionally the sacrificial anode is checked for the need to replace it when the boat is lifted out of the water, which is often undertaken once a year for general maintenance purposes. Alternatively a diver can be sent down for an underwater examination of the boat. Both the lift out and diver options are costly and require advance booking, often involving a delay of at least several weeks. Of course similar requirements exist for other reasons, for example to check for underwater damage to a hull after a collision or grounding or to ascertain the cause of a propeller failure, such as debris entangled with the propeller drive shaft. Similar difficulties arise in other areas, such as in the inspection of decay to the underwater portion of lock gates.

### SUMMARY OF THE INVENTION

To mitigate the difficulties of the prior art the present invention provides a remote viewing apparatus including a waterproof camera connected to a remote screen which receives video signals from the camera. To position the camera at the required location the invention provides an elongate pole to which the camera is attached. For convenience in use, in reaching the required location, as well as for convenience in storage when not in use, the pole is telescopic and capable of being locked at variable lengths against further changes in length. Importantly, according to the present invention the camera is attached to the end of the pole by a pliable connector which can readily be bent by hand and retain a required curvature. Thus, the camera can be position at precisely the required location and angle of view for optimum inspection of the object of interest.

Other features and advantages of the invention will become apparent from a reading of the following detailed description of preferred embodiments of the invention.

### BRIEF DESCRIPTION OF THE DRAWINGS

Embodiments of the present invention will now be described by way of further example only and with reference to the accompanying drawings; in which:

FIG. 1 is a schematic view of the apparatus according to the preferred embodiment of the present invention;

FIG. 2 is an enlarged perspective view of the camera unit of FIG. 1;

FIG. 3 is a further enlarged view showing the detail of the construction of the pliable connector of FIG. 1;

FIG. 4 is an enlarged sectional view showing the mode of coupling the camera unit to the pliable connector;

FIG. 5 shows the detail of the wand which terminates the pliable connector;

FIG. 6 is a perspective view of the clamp used on the telescopic pole of FIG. 1;

FIG. 7A is an enlarged sectional view of the clamp in its open position;

FIG. 7B is an enlarged sectional view of the clamp in its closed position;

FIG. 8 is a sectional view showing various portions of the telescopic pole;

FIG. 9 is a perspective view of the case used for the monitor shown in FIG. 1;

FIG. 10 is one example of an interchangeable camera, connector and wand unit; and

FIG. 11 is another example of an interchangeable camera, connector and wand unit.

### BEST MODE FOR CARRYING OUT THE INVENTION

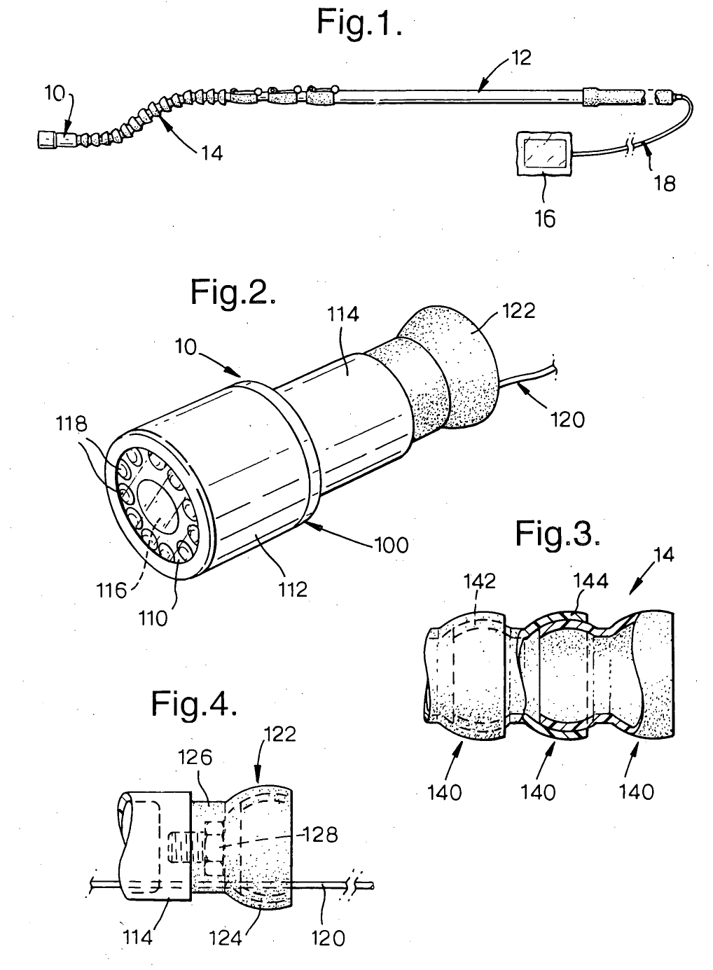

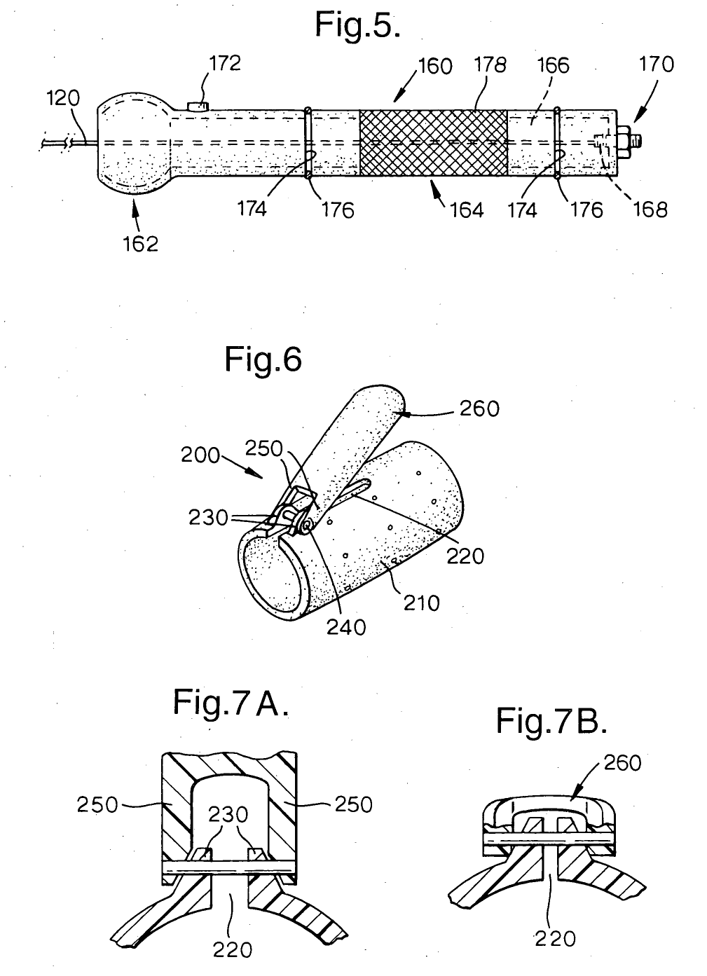

FIG. 1 illustrates the basic components of the preferred embodiment of the present invention. A camera 10 is attached to a telescopic pole 12 by a pliable connector 14. A monitor 16 receives video signals from the camera 10 via a cable 18.

The detail of the preferred arrangement of the camera 10 will now be described, with reference to FIG. 2. The camera 10 comprises a waterproof housing 100 having a transparent screen 110 at the front thereof. Generally the housing 100 has the form of a larger diameter cylinder 112 with a smaller diameter cylinder 114 projecting from the flat rear surface thereof. The larger, front cylinder houses a camera lens 116 surrounded by a plurality of white light LEDs 118. In use the lens 116 receives light from the LEDs 118, as well as ambient light, reflected from the object of interest. This is particularly useful in a marine environment where the underwater visibility may be restricted. In tests it has been found that sufficient illumination can be obtained in most marine environments at depths of 15 feet or more using 6 Volt conventional LEDs. Extending into the smaller cylindrical portion 114 of the housing 100 is a printed circuit board (not shown) to the front of which the lens 116 is fixed and which carries the main CCD (Charge Coupled Device) of the camera. The CCD receives and encodes colour images in to a conventional composite video signal (11 volts peak-to-peak output). The composite video output and a 12 volt DC input are connected between the circuit board and a waterproof connector (to be described later) by a waterproof cable 120. A coupling 122 (to be described in more detail later) is located on the flat face rear end of the small portion 114 of housing 100. The whole of the housing 100 shown in FIG. 2 is sealed in a waterproof manner, for example using gaskets and epoxy resin adhesives.

The construction of the pliable connector 14 will be explained with reference to FIG. 3, which is a cross-sectional portion, to an enlarged scale, of part of the connector. The connector 14 comprises a plurality of identical segments 140. Each segment 140 is of unitary moulded plastics construction combining a male portion 142 at one end with a female portion 144 at the other end. Both portions, 142 and 144, are generally bulbous in form with the female part 144 being larger in diameter than the male part 142 and the whole, 140 being open internally. As illustrated, the male portion of one segment is inserted into and retained by the female portion of the adjacent segment. The interconnection between the segments is a snap-fit and essentially provides a sequence of ball and socket joints, which can be oriented over a wide range of angle between adjacent segments. The friction between the engaged portions of the segments is such that the connector 14 can readily be bent by hand to provide the required curvature will retaining the given shape will the camera is manouvered underwater in to the desired position. One example of the interconnecting segments illustrated in FIG. 3 is “Snap-Loc” (TM) available from Cedarberg Industries Inc. of 1960 Seneca Road, Egan, Minn. 55122, USA. Generally the frictional fit between the segments 140 may not be sufficient to prevent the ingress of water. As a consequence it is preferable to provide several water drainage holes along the length of the interconnected segments 140. Such drainage holes can conveniently be located at the “waist” between the male and female portions of several of the segments 140.

Coupling 122 of housing 100 is illustrated in detail in FIG. 4. The coupling has a female portion 124 which is the same as the female portion 144 of any of the segments 140. In place of the male portion 142 of a normal segment 140 the coupling 122 has a short cylindrical portion 126. The female portion 124 receives the male portion 142 from the camera end of the pliable connector 14. The cylindrical portion 126 has a central bore and stepped portion by means of which the coupling 122 is secured to the rear end of the housing 100 (portion 114) by a marine grade stainless steel bolt 128 received in a threaded recess in housing 100. The cylindrical portion 126 has a bore through which the camera cable 120 passes, said bore being sealed with a waterproof adhesive (not shown).

The pliable connector 14 is preferably 12 to 18 inches in length. At the opposite end to the camera, the connector 14 terminates with a wand 160. The wand 160 is a solid, unitary and moulded plastics component having a bulbous male connector 162 at one end. The male connector is identical to the male portion 142 of any of the segments 140 and snap-fits with the female segment portion 144 at the free end of the sequence of interconnected segments 140. Apart from the male portion 162, the wand 160 has a cylindrical body 164. Body 164 has a central, longitudinal bore 166 which opens into the internal opening of male portion 162. The other end of body 164 is closed by an end wall having a narrower diameter, central bore 168 extending there through. Adhesively sealed, in a waterproof manner, within bore 168 is a waterproof electrical connector 170. Connector 170 terminates the cable 120 from camera 10. On the external surface of body 164 is a key 172 and two circular recesses 174. A respective O-ring 176 is received in each of the recesses 174. Key 172 and O-rings 176 are provided for assistance in attaching the wand 160 to pole 12, as will be described later. The external surface of the body 164 of the wand is also provided with a knurled portion 178. This knurled portion 178 acts a hand grip, for use as to be described later. The overall length of the wand is preferably 8 to 10 inches.

Telescopic pole 12 preferably comprises three sections, each having a length of 5 to 6 feet. One end of each of the three sections is provided with a clamp 200 of the form illustrated in FIG. 6. As will be readily appreciated, with two of the sections the clamp 200 locks at the chosen length of extension the pole section which slides within that carrying the clamp. The clamp at the end of the smaller diameter pole section grips the wand 160. Each clamp 200 has a generally tubular body 210 which is a friction fit and/or bonded to the end of the relevant pole section. The pole section is positioned so as to extend into the body 210 for approximately 50% of the length of the body 210. The free end of the body 210 is provided with a longitudinally extending slit 220. Slit 220 extends for 50% or less of the length of body 210. On the external surface of the clamp body 210 are provided two trunions 230, one adjacent either side of slit 220 at the free end of the body 210. Attached to each trunion 230 by a pivot pin 240 is a respective arm 250 of a lever 260. As shown in FIGS. 7a and 7b, the circumferentially outward facing sides of the trunions 230 are sloping so as to be thicker where they meet the outer cylindrical surface of the clamp body 210. The free ends of the arms 250 are shaped correspondingly so as to provide a cam action on pivoting of the lever 260. FIG. 7a is a cross-sectional view showing the lever 260 position perpendicularly to the clamp body 210 and slit 220 fully open. FIG. 7b shows the lever 260 pressed flat with the outer surface of the clamp body 210 and the slit 220 squeezed closed.

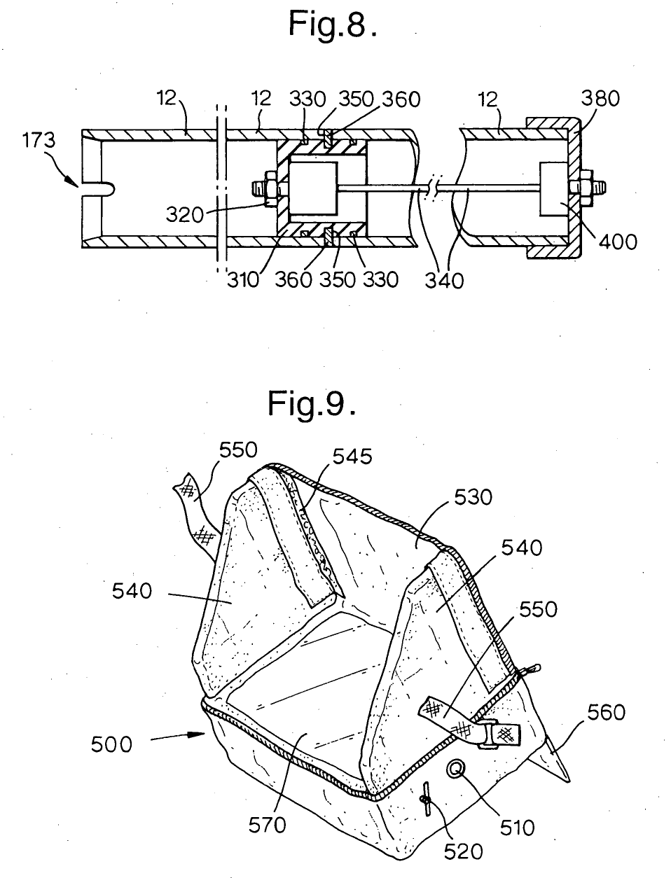

FIG. 8 is a cross-section of the end of the pole section which receives the wand 160. The end of the pole 12 has a short longitudinal slit 173 which is dimensioned to receive snugly the key 172 on the wand 160. Desired rotational alignment of the wand and pole is thus achieved. The open end of the pole 12 is chamfered, from the inner diameter towards the outer diameter, so as facilitate entry of the O-rings 176 into the hollow of the pole. When the wand 160 is fully inserted into the pole 12, the electrical connector 170 of the wand 160 mates with an electrical connector 300 located within pole 12. The electrical connectors mate in a waterproof fashion, which is provided by conventional and commonly available waterproof connectors. Connector 300 is fixed in a rubber bung 310. Bung 310 is in the form of a hollow cylinder open at one end. The other end of the bung is closed by an end wall, but the end wall is provided with a central bore through which a reduced diameter portion of the connector 300 extends. The connector and bung are fixed together by a lock nut 320 which engages a thread on the end of the reduced diameter portion of the connector 300. The external cylindrical surface of the bung 310 is provided with two circumferential recesses, in each of which is located a respective O-ring 330. O-rings 330 ensure a good frictional fit of the bung within the pole.

The method of locating the connector 300 at the correct position within the pole 12 will now be described. First the connector 300 is assembled with its output cable 340 attached in a waterproof manner, for example soldered and then encapsulated in epoxy resin (not shown). The connector 300 is fitted in the bung 310 and the locking nut 320 fully tightened. O-rings 330 are located in their respective recesses. With the output lead extending along the entire length of the pole 12, connector 300 is coupled with connector 170 on wand 160. Wand 160 is then fully inserted into the end of the pole. A number of fixing holes 350 are then drilled through the wall of the pole 12 (or are preferably predrilled at the correct distance from the end of the pole) and then drilled into the bung 310. Next the fixing holes, as extended into the bung, are filled with a high strength epoxy adhesive which, when set, constitutes fixing plugs 360.

Output cable 340 is pre-formed as a helical coil, in the well known manner used for example for telephone hand-pieces. Thus, the cable easily accommodates the telescoping action of the pole sections. The free end of the larger diameter section of pole 12 is closed by a cap 380 which is a friction fit and/or adhesively sealed to the end of the pole. Located in cap 380 is an electrical connector 400. Connector 400 is similar to connector 300 and is fitted to the cap in essentially the same manner that connector 300 is fitted to bung 310. With the wand 160 fully inserted in to the other end of the pole, electrical power and signals can thus be established between the camera 10 and the connector 400 at the other end of the pole.

Since the junctions between the sliding sections of the telescopic pole 12 are unlikely to be watertight water drainage holes are provided along the length of the pole 12 and may also be provided in the cap 380.

As shown in FIG. 1, a cable 18 interconnects the pole 12 with the monitor 16. Cable 18 has a connector at one end which mates with connector 400 of pole 12 and at the other end has a jack-plug which mates with a jack socket in the casing of the monitor 16.

Monitor 16 is provided in a portable housing 500. The viewing screen itself is a conventional TFT panel capable of displaying a colour image from the composite video signal provided by camera 10. The TFT panel is provided with a standard set of controls, for example for adjusting picture brilliance and colour saturation. The screen is powered by two 6 volt sealed lead acid batteries rated at 1.2 Ah and connected in series to provide a 12 volt supply for the screen. The batteries are housed in case 500, below the screen and are connected thereto via a conventional voltage regulator.

In one side of the case 500 is the jack plug socket 510 which receives the jack plug (not shown) of cable 18. Jack plug socket 510 is connected to supply the composite video signals from camera 10 to the screen and is also connected to the above described batteries so as to supply power to camera 10 and LEDs 118. In the case 500, adjacent socket 510, is a three position toggle switch 520. Two of the positions of the toggle switch 520 are respectively on/off positions for the monitor/camera and LEDs. The third position of switch 520 is used to change the operation of socket 510 so that the said batteries can be recharged when a suitable charging unit (transformer connect to a mains electricity supply) is plugged in to the socket. Optionally the case 500 may be provided with an output socket (not shown) which is wired in parallel with socket 510 to enable the connection of another device which can use the composite video signal. In particular this feature is useful for connecting a digital video recorder to the monitor.

Preferably case 500 is made from a rugged and waterproof (rain proof) fabric. Thus the case has a lid 530 with a zip for opening and closing it with the main body of the case. Sun visor side flaps 540 fold flat over the screen when the case is closed and when open they connect to the lid 530 by Velcro™ tabs 545 so as to keep both the lid and the flaps in the open position. A neck strap 550 allows the monitor 16 to be carried by an operator in a hands free manner, and in suitable position for easy viewing of the screen when deploying the camera. Also provided is a rigid under-base flap 560 which can be deployed to tilt the monitor at an easy viewing angle when it is rested on a flat surface. Preferably a splash and/or rain proof transparent cover is provided over the TFT screen. Internally the case 500 has a foam insert with cut-outs to receive and locate snugly the batteries, voltage regulator and screen. Cut-outs are also provided for the required wiring harness and power supply fuse.

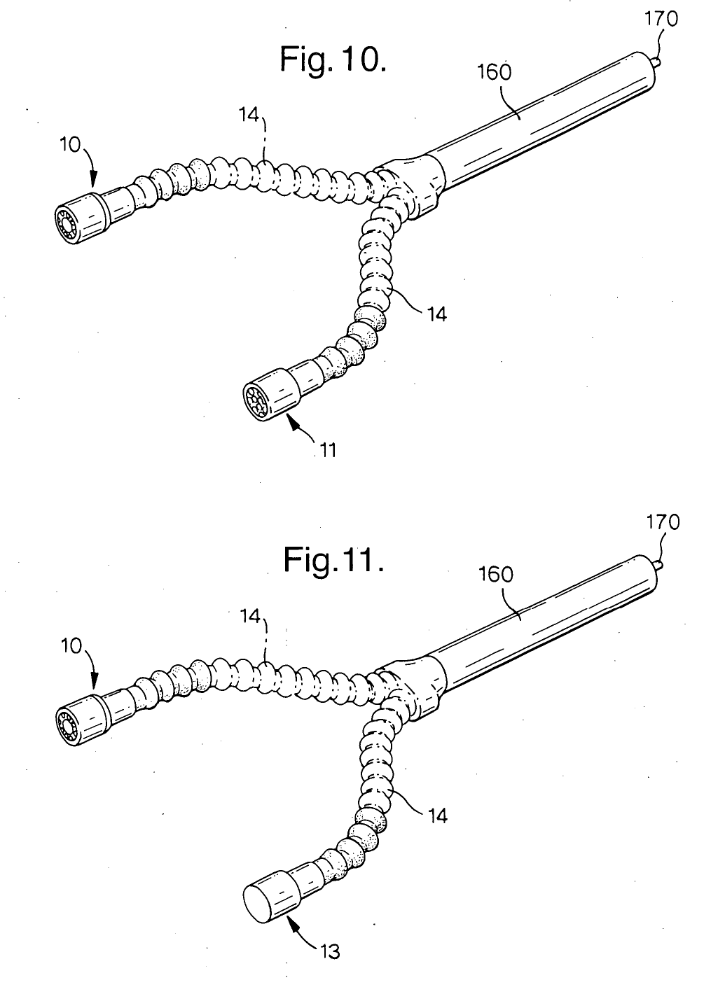

It is important to note that the assembled camera housing 100 and pliable connector 14, including the wand 160 constitutes a separate, self contained unit. This unit can be hand-held and connected directly to the monitor 16. Hence the provision of the knurled hand-grip 178. Such a self contained unit configuration is particularly useful when remote viewing is required in a confined space; for example internally of a boat for viewing spaces in and around the engine compartment. It is also an important feature of the invention that the arrangement permits a plurality of different units to be used interchangeably with the pole 12 and monitor 16. FIGS. 10 and 11 depict examples of some of the interchangeable units which may be provided. In FIG. 10 a bifurcated pliable connector 14 is used so as to provide on one arm the camera and LED component shown in detail in FIG. 2 while on the other arm is provided a similar unit 11 which does not have a camera but instead has additional LEDs. This twin armed unit is useful when the object for inspection is in particularly murky water. FIG. 11 illustrates a twin armed unit similar to that shown in FIG. 10, but in this example the additional lighting unit 11 is replaced by a strong magnet 13. This unit enables the apparatus to be used for the recovery of underwater ferrous objects—such as metal tools or keys accidentally dropped overboard in shallow water.

Although the invention has been described herein primarily in terms of an apparatus for use in the underwater inspection of objects, it can of course equally be used in other circumstances. One example is use of the apparatus for the easy inspection of the gutters of a house, where the telescopic pole and pliable connector enable the camera easily to be position to shown an operator on the ground whether or not the gutters are blocked with leaves or other debris.

The aforegoing description has been given by way of example only and it will be appreciated by a person skilled in the art that modifications can be made without departing from the scope of the present invention.

What I claim is:

1. A remote viewing apparatus comprising:
a camera which operatively outputs a video signal;
a waterproof camera housing in which the camera is enclosed;
a telescopic pole;
a wand which is releasably retained at one end of the telescopic pole;
a pliable mechanical connector which connects the camera housing to the wand and which can be reversibly bent by hand to, and retain, a curved shape; and
a monitor which operatively displays a picture using the video signal output by the camera.

2. A remote viewing apparatus as claimed in claim 1, wherein the camera has a field of view and the said camera housing houses a plurality of light sources which operatively illuminate the said field of view.

3. A remote viewing apparatus as claimed in claim 1, wherein the pliable mechanical connector comprises a sequence of interconnected longitudinal segments with each segment having a male coupling at one end and a female coupling at the other end such that ball and socket like couplings are established at the interconnections between the segments.

4. A remote viewing apparatus as claimed in claim 1, comprising: a cable via which the camera outputs the said video signal; and an electrical connector fixed to the wand and to which the said cable is connected in a waterproof manner.

5. A remote viewing apparatus as claimed in claim 4, comprising an electrical connector fixed at the said one end of the telescopic pole at which the wand is releasably retained and which operatively forms a waterproof electrical connection with the said electrical connector fixed to the wand when the wand is retained at the said one end of the telescopic pole.

6. A remote viewing apparatus as claimed in claim 5, comprising: an electrical connector fixed at the opposite end of the pole to the said one end of the pole at which the wand is releasably retained; and a helically wound electrical cable which electrically interconnects the electrical connectors provided at either end of the pole.

7. A remote viewing apparatus as claimed in claim 6, further comprising: an electrical cable which electrically interconnects the said electrical connector fixed at the said opposite end of the pole to the monitor.

8. A remote viewing apparatus as claimed in claim 1, comprising key on the wand and means defining a slit, the said means being positioned at the said end of the pole at which the wand is releasably retained, whereby the key mates with the slit when the wand is retained by the pole such that correct orientation and interconnection is established between the electrical connector fixed to the wand and the electrical connector fixed at that end of the pole at which the wand is retained.

9. A remote viewing apparatus as claimed in claim 1, comprising at least one O-ring located on the external surface of the wand and providing a seal with the pole when the wand is retained in the pole.

10. A remote viewing apparatus as claimed in claim 1, wherein the external surface of the wand is provided with a hand grip.

11. A remote viewing apparatus as claimed in claim 5, further comprising a bung in which is fixed the electrical connector of the pole which connects to the electrical connector of the wand, the bung being fixed internally of the pole.

12. A remote viewing apparatus as claimed in claim 11, wherein the bung is fixed internally of the pole by one or more resin plugs which extend through respective holes in the wall of the pole.

13. A remote viewing apparatus as claimed in claim 11, comprising at least one O-ring located on the external surface of the bung and providing a seal with the internal surface of the pole.

14. A remote viewing apparatus as claimed in claim 3, comprising a male coupling or a female coupling on the waterproof camera housing such that a ball and socket like coupling is established at the interconnection between the housing and the pliable connector.

15. A remote viewing apparatus as claimed in claim 3, comprising a male coupling or a female coupling on the wand such that a ball and socket like coupling is established at the interconnection between the wand and the pliable connector.

16. A remote viewing apparatus as claimed in claim 1, wherein the telescopic pole comprises three sections and two releasable locking clamps, the locking clamps enabling the said sections to be locked relative to each other so as to provide a locked pole of variable length.

17. A remote viewing apparatus as claimed in claim 1, comprising a locking clamp which locks the wand and the pole together when the wand is retained by the pole.

18. A remote viewing apparatus as claimed in claim 16, wherein each locking clamp comprises: a tubular body part of which defines a slit; two trunions provided on the tubular body each adjacent a respective longitudinal side of the slit; a lever having two arms with each arm being pivotally attached to a respective one of the trunions; and the arms and trunions having cam surfaces whereby pivoting of the arms on the trunions closes and opens the said slit thereby providing a locking action.

19. A remote viewing apparatus as claimed in claim 1, wherein the monitor includes a TFT screen.

20. A remote viewing apparatus as claimed in claim 1, wherein the monitor includes one or more batteries.

21. A remote viewing apparatus as claimed in claim 20, wherein the said one or more batteries are rechargeable.

22. A remote viewing apparatus as claimed in claim 20, wherein the monitor comprises a socket and a switch, the switch changing electrical connections from the socket between connection to the camera and connection to a recharging unit for the batteries.

23. A remote viewing apparatus as claimed in claim 1, comprising a case in which the monitor is housed.

24. A remote viewing apparatus as claimed in claim 23, comprising a neck strap releasably attachable to the case.

25. A remote viewing apparatus as claimed in claim 23, wherein the case comprises a lid having open and shut positions and two side flaps each having open and shut positions, the lid and side flaps being arranged to mutually support each other in the said open positions.

26. A remote viewing apparatus as claimed in claim 23, wherein the case comprises a transparent splash proof screen.

27. A remote viewing apparatus as claimed in claim 23, wherein the case comprises a bottom flap which is deployable to hold the monitor at an inclined angle when the case is supported on a horizontal surface.

28. A remote viewing apparatus as claimed in claim 23, wherein the case comprises a fabric cover.

29. A remote viewing apparatus as claimed in claim 23, wherein the case comprises a foam insert.

30. A remote viewing apparatus as claimed in claim 1, wherein the camera housing, including the camera therein, the pliable connector and the wand constitute a single unit.

31. A remote viewing apparatus as claimed in claim 30, wherein the said single unit is operatively connectable to the monitor selectively by direct connection or by connection via the telescopic pole.

32. A remote viewing apparatus comprising:
a monitor which operatively displays a picture using a video signal;
a telescopic pole; and
a plurality of interchangeable units; each of the interchangeable units including at least:
a camera which operatively outputs a video signal to be used by the monitor;
a waterproof camera housing in which the camera is enclosed;
a wand which is releasably retained at one end of the telescopic pole; and
a pliable mechanical connector which connects the camera housing to the wand and which can be reversibly bent by hand to, and retain, a curved shape.

33. A remote viewing apparatus as claimed in claim 32, comprising an interchangeable unit in which the pliable connector is bifurcated in to two arms with the camera housing being provided on one of the arms and an auxiliary device is provided on the other of the arms.

34. A remote viewing apparatus as claimed in claim 33, wherein the auxiliary device is a light source.

35. A remote viewing apparatus as claimed in claim 33, wherein the auxiliary device is a magnet.
